(19) United States
(12) Patent Application Publication
(10) Pub. No.: US 2012/0079028 A1
(43) Pub. Date: Mar. 29, 2012

(54) CONTENT SHARING SYSTEM PERFORMANCE IMPROVEMENT

(76) Inventors: Ayodele Damola, Solna (SE); Bob Melander, Sigtuna (SE); Jan-Erik Mangs, Solna (SE)

(21) Appl. No.: 13/322,788

(22) PCT Filed: May 29, 2009
(86) PCT No.: PCT/SE09/50619

§ 371 Date: Dec. 15, 2011

(51) Int. Cl. G06F 15/16

(52) U.S. Cl. 709/204

(57) ABSTRACT

Embodiments of the present invention relate to a system for improving performance of a content sharing system comprising content sharing clients, whereby storage means and logic means for content chunk disposed by a client is separated into different physical hosts.

### TECHNICAL FIELD

The present invention generally relates to systems and methods and, more particularly, to mechanisms and techniques for improving performance of a content sharing system.

### BACKGROUND

Peer To Peer P2P applications, including streaming applications, are becoming commonplace on the PC and it foresee that they will make their way into networked Consumer Electronic CE devices (e.g. MP3 players, media players etc). P2P streaming applications will also be available on mobile phone devices. Examples of P2P streaming applications are Joost (video) and Spotify (music).

The current P2P applications assume that the P2P client and the storage of the content exchanged by the client are a single entity. See for example the implicit reference to the collocation between logic and storage: http://users.cs.cf.ac.uk/Ian.J.Taylor/DistributedSystems/PP TSlides/BittorentLecture.ppt. This link points to a presentation on the way Bittorent client works. Slides 17-18 shows peers exchange messages with the tracker. Peer A hosts the logic supporting this. Slide 19 shows peer A perform shake-hand with other peers. Peer A hosts the logic supporting this. Slides 20-21 show peer A getting the pieces. Peer A also stores the pieces. From the above it can be seen that a P2P client (peer A in this example) hosts the P2P logic as well as stores the content it gets from other peers.

While this is relevant for many PC based applications, the concept is inflexible and will be a restricting factor when there is a need to separate P2P control logic from storage entities.

For example, when running a P2P client on the edge of a network, for example in the end user terminal, where network resources (like bandwidth) might be very limited and/or be charged as a metered service at a prohibitively high cost, client and storage in a single entity does not make much sense.

In another example, it may be desirable to centralize the P2P control processing to one or a few nodes inside the network core while distributing storage nodes close to (end-user) terminals. This is not possible with current P2P clients and leads to unnecessary transfers of content in the mobile network core.

### SUMMARY

An aim of the invention is to overcome above identified limitations of the prior art. The invention focuses on the locating of storage facilities for the content in an optimized way, to prevent back-haul of needed bandwidth and reduce bandwidth consumption.

The basic concept of the invention is the separation of storage facilities and logic of applications in different physical hosts.

The solution more in detail is a system for improving performance of a content sharing system comprising content sharing clients, wherein storage means and logic means for content chunk disposed by a client is separated into different physical hosts.

According to one exemplary embodiment a system and a method for optimizing logic and storage facilities has been described whereby logic facilities have been located at edge user position while storage facilities have been located at a central position.

According to another exemplary embodiment a system and a method for optimizing logic and storage facilities has been described whereby logic facilities have been located at a central position while storage facilities have been located at edge user positions.

According to yet other exemplary embodiments, a central node and a node at edge user position according to the invention have been described.

An object of the invention is to reduce negative traffic impact caused by bandwidth consumption. This object and others are achieved by systems, methods, arrangements and nodes.

Advantages of the invention are an attained reduction of accessing latency time of stored content as a result of splitting the logic and storage components. The amount of back-haul bandwidth needed is also reduced since the storage part of a control node can be situated close to edge-users. Furthermore, distributed storage architecture can now be implemented for caches of P2P content in mobile operator networks.

The invention will now be described more in detail with the aid of preferred embodiments in connection with the enclosed drawings.

### BRIEF DESCRIPTION OF THE DRAWINGS

FIG. 1 is a schematic illustration of a communication system comprising a plurality of clients, connected to a core network via a mobile access network, and connected to an internet network. A storage facility for content chunk is according to the invention hosted by a central node while logic facilities are hosted at edge user position.

FIG. 2 discloses a signal sequence diagram representing a method for distributing content by utilizing the system configuration disclosed in FIG. 1.

FIG. 3 is a schematic illustration of a communication system comprising a plurality of clients, connected to a core network via a mobile access network, and connected to an internet network. Storage facilities for content chunk are according to the invention hosted at edge user positions while a central node hosts logic facilities.

FIG. 4 discloses a signal sequence diagram representing a method for distributing content by utilizing the system configuration in FIG. 3.

FIG. 5a discloses a block schematic illustration of logic facilities at edge user position and storage facilities in a node at a central position.

FIG. 5b discloses a block schematic illustration of logic facilities at central position and storage facilities in a node at an edge user position.

### DETAILED DESCRIPTION

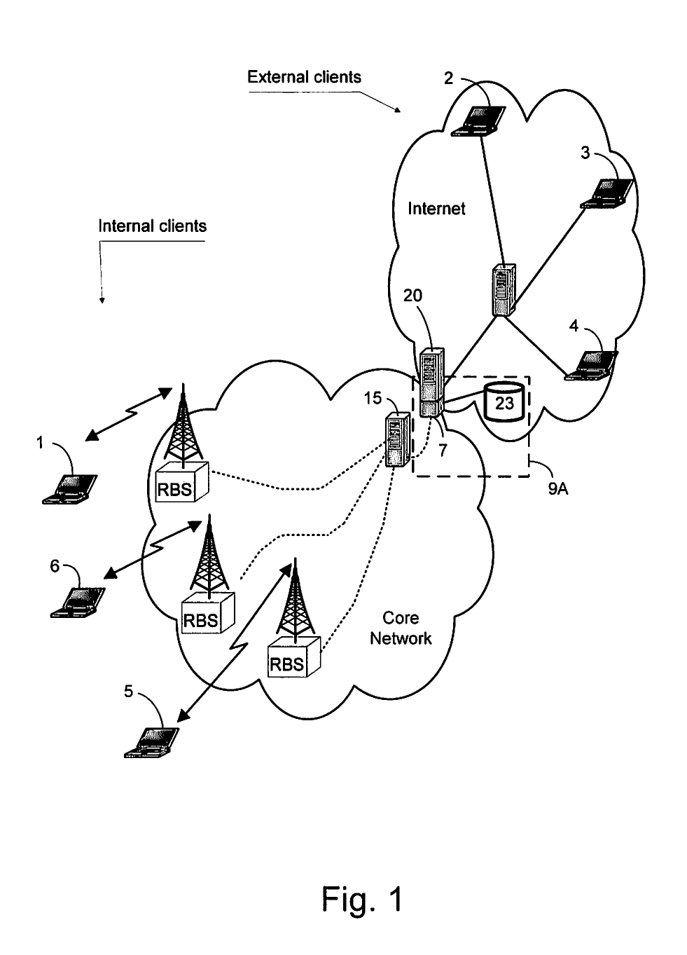

FIG. 1 discloses a first exemplary embodiment of the invention. The figure shows a system comprising a peer to peer P2P network that includes plural peers/clients 1-6 (laptops in this example). The laptops 2, 3, 4, so called External clients, are connected via access networks (not shown in the figure) to an internet network, and laptops 1, 5, 6, so called Internal clients, are connected via a mobile access network to a Core Network. The figure discloses a very simplified example and the number of clients are in the reality much higher. The clients may be, for example, a mobile phone, a computer, a set top box, or other devices that are capable of exchanging information with the internet, i.e. even though connected via a mobile access, also the clients 1, 5, 6 can be either wireline or wireless clients. The access networks connecting the laptops 2, 3, 4 can be for example a communication network, a phone network, an Internet service provider, etc.

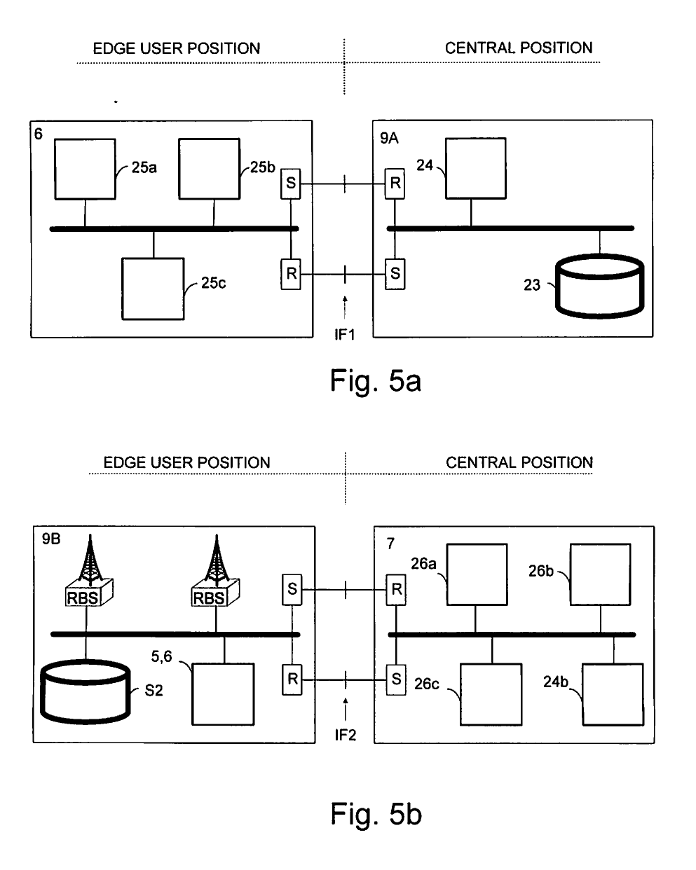

The mobile network and the core network together constitutes a 3^{rd} Generation Partnership Project (3GPP) mobile network. The architecture of the 3GPP mobile network is built around tunneling. In FIG. 1 a signaling gateway acts as a tunnel terminating node and a Packet Data Network GateWay PDN GW 20 is the tunnel ingress/egress point for all internet traffic. All traffic from/to the radio based laptops 1, 5, 6 will go through 20. In this network, the clients 1, 5, 6 each are given an IP address that is topologically anchored in a signaling gateway 15, regardless of where the client device actually is located in the IP domain. The tunnels are shown in FIG. 1 with dotted lines. The packet Data Network GateWay 20 is the tunnel ingress/egress point for all internet traffic and all traffic from/to the radio based laptops 1, 5, 6 will go through the gateway 20. A P2P control node 7 (PCN) is part of the packet Data Network GateWay 20. The PCN will be further explained together with for example FIG. 5.

The centrally located P2P control node PCN 7 is implemented into the node 20 where tunnels are terminated. The significance of placing the PCN into the PDN GW 20 is that it is the ingress/egress point for all internet traffic; hence all the traffic from/to the mobile peers will go through this central node and the central PCN node will be in the signaling path of the P2P traffic. A storage facility 23 is in this first embodiment hosted by the central control node 7 according to the invention. In FIG. 1 the central node 7 and the storage facility 23 together constitutes a performance improving node 9A at a central position. The node 9A will be further explained in FIG. 5A.

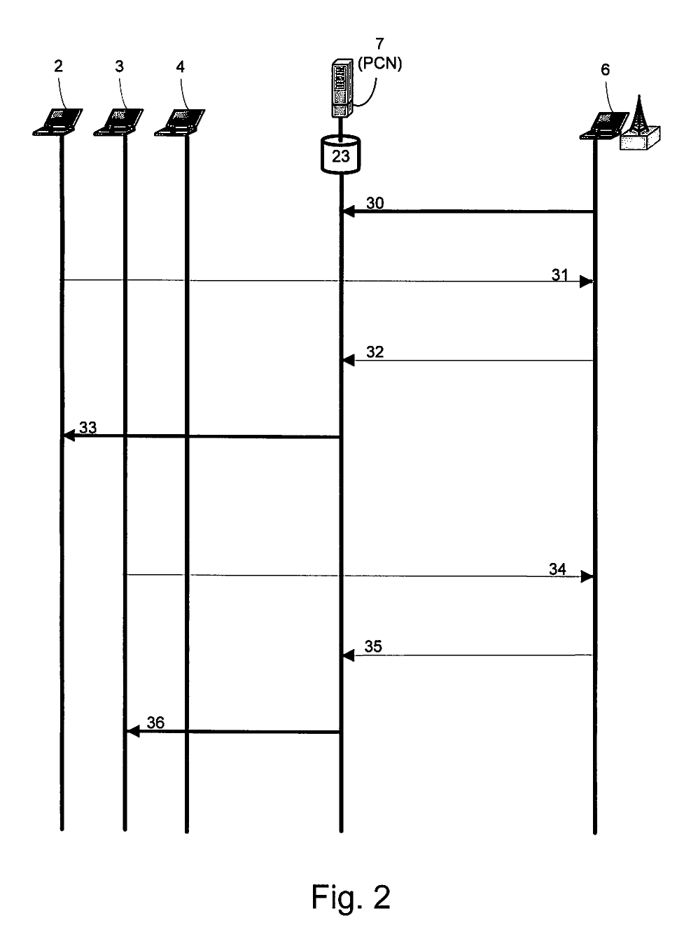

The system and method according to the first embodiment will now be further explained together with FIG. 2. FIG. 2 is a signal sequence diagram wherein the signalling points i.e. the laptops 2-4 and 6, the central node 7 and the storage facility 23 that were explained earlier together with FIG. 1, have been disclosed. The method will further explain means comprised in the system according to the invention, together with method steps. The method will illustrate the improvement of performance in the Peer To Peer content sharing system when the system configuration shown in FIG. 1 is used. The method comprises the following steps:

In a first method step, the radio based laptop 6, from now on called the mobile client 6 at some point according to the invention downloads content 30, received from other clients, to a location closer to the external clients. In this example the node 7 has been selected as host for the content chunk. Content chunk is by definition a part of the content, which part can be of various sizes. So, while maintaining P2P functionality comprising the logic facilities needed for downloading content from other clients, forming search queries to other clients and answering search queries from other clients etc. as before, i.e. hosted by the mobile client 6, storage facilities 23 for content chunk is now hosted at a location closer to clients that are expected to request content chunk. To be noted is that the content chunk that now is hosted by the central node 7 still is registered by the P2P system as hosted by the mobile client 6.

A request 31 for content chunk that is registered by the P2P system as hosted by the mobile client 6 but in fact is hosted by the central node 7, is sent from a requesting external client 2 to the mobile client 6.

The P2P logic facility maintained in the mobile client 6 sends an instruction 32 to the central node 7 to serve the requested content chunk, now hosted in 7, to the content requesting external client 2.

The central node 7 serves the requested content chunk to the requesting external client 2.

When another external client 3 request 34 the content chunk from the mobile client 6, the mobile client will instruct 35 the central node 7 to serve the chunk in the same manner as described above.

In the example above bandwidth consuming transfers of content has been disclosed in the figure with thick arrows 30, 33 and 36 while signalling (less bandwidth consuming) has been disclosed with thin arrows 31, 32, 34 and 35. As can be understood from the figure, bandwidth consumption decreases in the network when the content is centrally located. The more popular the content is, the more bandwidth (that might be very limited) is saved.

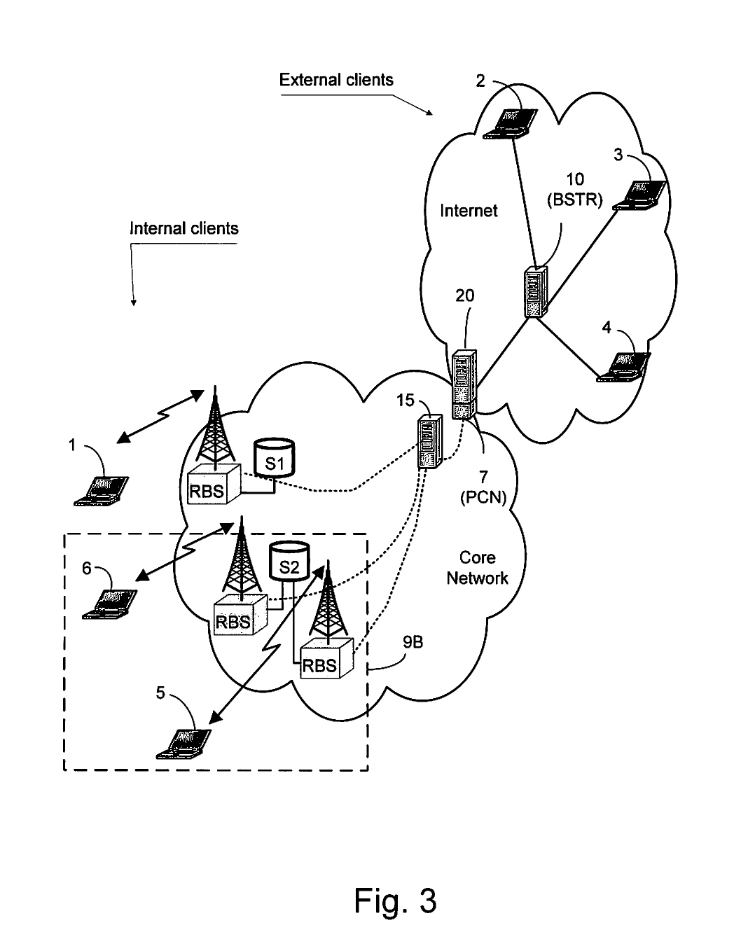

FIG. 3 discloses a second exemplary embodiment of the invention. The figure shows generally same system as was disclosed in FIG. 1 i.e. the peer to peer P2P network that includes plural peers/clients 1-6. The centrally located P2P control node PCN 7 is like in FIG. 1 implemented into the node 20 where tunnels are terminated. A bootstrapping server BSTR 10 is in this example located within the Internet. The bootstrapping server functions as a directory service for clients participating in the P2P network. The bootstrapping server is responsible for creating a distribution tree based on participating nodes. According to prior art, in P2P streaming applications for peers to become part of the P2P network they have to send register messages to a bootstrapping server 10. The bootstrapping server would assign the new peers a parent peer from a list of already existing peers and in so doing will create a new branch of the P2P distribution tree. A reply is sent back to the new peers indicating the parent peer. Upon getting the reply, the new peers become part of a tree in the P2P network and may start sending content requests to the parent peer. In this second embodiment no storage facility is hosted by the central node 7. Instead storage facilities S1-S2 are arranged at edge user positions in FIG. 3. In FIG. 3 the clients 5 and 6 as well as the radio base stations RBS that serve the mobile clients 5 and 6, and the storage facility S2 together constitutes a performance improving node 9B at an edge user position. The node 98 will be further explained in FIG. 5B.

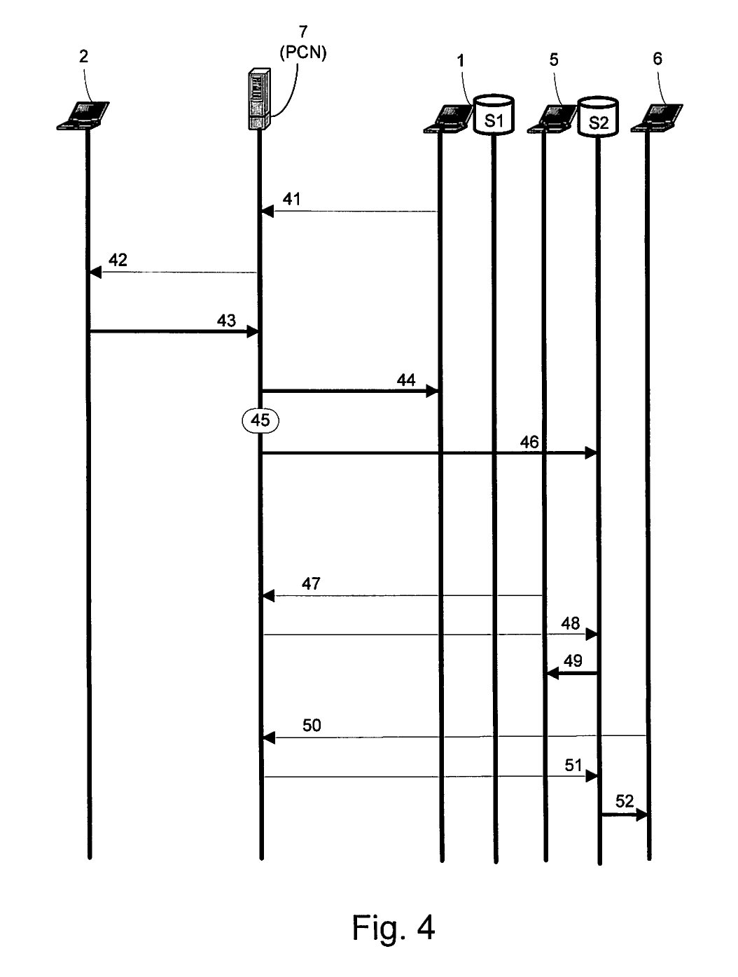

The system and method according to the second embodiment will now be further explained together with FIG. 4. FIG. 4 is a signal sequence diagram wherein the signalling points i.e. the laptops 2, 1, 5 and 6, the central node 7 and the storage facility S1-S2 that were explained earlier together with FIG. 3 have been disclosed. The nodes are arranged in a tree structure whereby the central node 7 is a regular node for the external client 2 in the tree and also a parent node for internal clients 1, 5, 6. The central node 7 might be an operator controlled entity. The method will further explain means comprised in the system according to the second embodiment of the invention, and will illustrate the improvement of performance in the Peer To Peer content sharing system when the invention is used. The method comprises the following steps:

A request 41 for content chunk is sent from a requesting internal mobile client 1 to the internal client's parent node, i.e. to the central node 7.

The central node 7 fetches the chunk from the P2P network. This is inline with P2P streaming system operation. The request 41 is hereby forwarded 42 from the central node 7 to the content holding external client 2. The request 41 is in this example modified before forwarding so that 7 appear to be the requesting node.

The content chunk is delivered 43 from the external client 2 to the central node 7.

The received content chunk is served 44 from the central node 7 to the requesting internal mobile client 1.

A storage decision 45 is made in the central node 7. The storage decision takes request rate for the content chunk into consideration. An expected high request rate will result in a positive storage decision. The expected high rate is assumed to be popularity of the specific content file which indicates the measure of probability with which the same file will be requested by other end users. A popularity threshold can for example be set and if the popularity threshold for a given file is exceeded its deemed popular and a positive storage decision is made.

As a consequence of a positive storage decision, the central node 7 forwards 46, via RBS, the content chunk received from the external client 2, to the storage facility S2 at edge user position close to the requesting client 5.

A request 47 for content chunk is sent from a requesting internal mobile client 5 to the internal client's parent node i.e. to the central node 7.

The central node 7 instructs 48 the storage facility

S2 to serve this content to the requesting peer 5. This instruction is a signaling message.

The storage facility S2 serves 49 the content chunk to the requesting internal mobile client 5 via the Radio Base Station RBS that serves 5 (see also FIG. 3).

A request 50 for content chunk is sent from another requesting internal mobile client 6 to the internal client's parent node i.e. to the central node 7.

The central node 7 instructs 51 the storage facility S2 to serve this content to the requesting peer 6.

The storage facility S2 serves 52 the content chunk to the requesting internal mobile client 6 via the Radio Base Station RBS that serves 6 (see also FIG. 3).

In the example above bandwidth consuming transfers of content has been disclosed in the figure with thick arrows 43, 44, 46, 49 and 52 while signalling (less bandwidth consuming) has been disclosed with thin arrows 41, 42, 47, 48, 50 and 51. As can be understood from the figure, bandwidth consumption decreases in the network when the content is located at edge user position.

FIG. 5a discloses a block schematic illustration of a central performance improving node 9A attached via an interface IF1 to a node 6 at edge user position. In the example in FIG. 5a the node 6 is the same entity as the client 6 that was shown in the first embodiment. The central node is a first physical host for storage facilities for content chunk disposed by a client, for example client 6 as described in the first embodiment. The node 6 is a second physical host, for a P2P logic part for the content chunk. The P2P logic part is the main P2P application which consists of processes 25a-c responsible for downloading content from the network, forming search queries and answering search queries from other peers. The communication between the central and edge user position nodes 9A and 6 has been described in the first embodiment and takes place via sender means S and receiver means R in 9A and 6. The downloading 30 (see FIG. 2) of content from node 6 to the storage 23 in the central node 9A hereby takes place via the interface IF1. Also the instruction 32 (see FIG. 2) is sent via IF1 from the node 6 to the central node 9A. A message processing logic 24 in 9A is responsible for forwarding the received content chunk to the storage 23 and to attend to the instructions received from node 6 i.e. to serve requested content chunk to content requesting external clients.

FIG. 5b discloses a block schematic illustration of a performance improving node 9B at edge user position attached via an interface IF2 to a node 7 at central position. The node at edge user position is a first physical host for storage facilities for content chunk disposed by a client, for example client 2 as described in the second embodiment. The node 7 is a second physical host, for a P2P logic part for the content chunk. The P2P logic part consists of processes 26a-c responsible for downloading content from the network, forming search queries and answering search queries from other peers. The communication between the edge user position node 9B and the central node 7 has been described together with the second embodiment and takes place via sender means S and receiver means R in 9B and 7. A message processing logic 24b in 7 is responsible for executing the storage decision by taking request rate for the content chunk into consideration. The message processing logic 24b is also responsible for forwarding 46 (see FIG. 4) the content chunk received from external clients, to a storage facility S2 in the node 9B as well as sending of the instruction 48 (see FIG. 4) to the storage facility S2 in 9B, to serve content to a requesting peer. The clients 5 and 6 are part of 9B. The storage facility S2 serves the content chunk to a requesting internal mobile client via one of the Radio Base Station RBS that can be seen within node 9B in the FIGS. 3 and 5B.

To be noted is that the nodes described in FIG. 5A and 5B are just to be seen as examples of such nodes, storage facilities and logic facilities may for example be stored outside as well as inside the nodes.

As will be obvious to someone skilled in the art, the peers do not have to be separated into external and internal peers but instead all involved peers may be located in the same operator network. The storage facility can be divided on several places. Furthermore, as an example, that an internal client “hosts” storage facilities do not necessarily mean that the storage is located within the internal client's laptop, instead it means that the facility is under the influence of the internal client. In the described embodiments, examples of hosts for storage and/or logic facilities are 6, 7, 9A and 9B.

A system that can be used to put the invention into practice is schematically shown in the FIGS. 1, 3 and 5. Enumerated items are shown in the figures as individual elements. In actual implementations of the invention, however, they may be inseparable components of other electronic devices such as a digital computer. Thus, actions described above may be implemented in software that may be embodied in an article of manufacture that includes a program storage medium. The program storage medium includes data signal embodied in one or more of a carrier wave, a computer disk (magnetic, or optical (e.g., CD or DVD, or both), non-volatile memory, tape, a system memory, and a computer hard drive.

The systems and methods of the present invention may be implemented for example on any of the Third Generation Partnership Project (3GPP), European Telecommunications Standards Institute (ETSI), American National Standards Institute (ANSI) or other standard telecommunication network architecture. Other examples are the Institute of Electrical and Electronics Engineers (IEEE) or The Internet Engineering Task Force (IETF).

The description, for purposes of explanation and not limitation, sets forth specific details, such as particular components, electronic circuitry, techniques, etc., in order to provide an understanding of the present invention. But it will be apparent to one skilled in the art that the present invention may be practiced in other embodiments that depart from these specific details. In other instances, detailed descriptions of well-known methods, devices, and techniques, etc., are omitted so as not to obscure the description with unnecessary detail. Individual function blocks are shown in one or more figures. Those skilled in the art will appreciate that functions may be implemented using discrete components or multi-function hardware. Processing functions may be implemented using a programmed microprocessor or general-purpose computer. The invention is not limited to the above described and in the drawings shown embodiments but can be modified within the scope of the enclosed claims.

1. A system for improving performance of a content sharing system comprising content sharing clients, wherein storage means and logic means for content chunk disposed by a client is separated into different physical hosts.

2. The system for improving performance of a content sharing system according to claim 1, whereby the clients are arranged so that a central node is situated on a signalling path between external clients and internal clients, wherein an internal client hosts logic facilities for the content chunk, and the central node hosts storage facilities for the content chunk.

3. The system for improving performance of a content sharing system according to claim 1, whereby the clients are arranged so that a central node is situated on a signalling path between external clients and internal clients, wherein the central node hosts logic facilities for the content chunk and at least one internal client hosts storage facilities for the content chunk.

4. The system for improving performance of a content sharing system according to claim 2, which system further comprises:
means in the internal client adapted to instruct the central node to deliver requested content chunk to a requesting client;
means in the central node adapted to deliver the requested content chunk to the requesting client.

5. The system for improving performance of a content sharing system according to claim 3, which system further comprises:
means in the central node adapted to receive a request for content chunk from a first requesting internal client;
means to forward the received request adapted to an external client in disposal of the requested content;
means in the central node adapted to receive the requested content chunk from the external client;
means in the central node adapted to forward the chunk to the first requesting internal client;
means in the central node adapted to forward the content chunk to storage facilities hosted by at least one of the internal client.

6. The system for improving performance of a content sharing system according to claim 5, which system further comprises:
means in the central node adapted to make a storage decision.

7. The system for improving performance of a content sharing system according to claim 6 which storage decision is adapted to take request rate for the content chunk into consideration.

8. The system for improving performance of a content sharing system according to claim 5, which system further comprises:
means in the central node to receive a request for the content chunk from a second requesting internal client;
means in the central node to instruct a storage facility in possession of the requested chunk to deliver the stored content;
means in the storage facility to deliver the content to the second requesting client.

9. The system for improving performance of a content sharing system according to claim 1, whereby the clients are arranged in a tree structure and the central node is a regular node for external clients in the tree and also a parent node for internal clients in the tree.

10. The system for improving performance of a content sharing system according to claim 1, whereby the central node is located at the edge of the operator's network whereby the internal clients are accessible via the operator's network and the external clients are accessible via a network outside the operator's network.

11. The system for improving performance of a content sharing system according to claim 1, wherein the central node is an operator controlled entity.

12. The system for improving performance of a content sharing system according to claim 1, wherein the operator's network is a mobile network and an internal client access the network via a mobile network node to which there is a collocation with at least one storage facility.

13. A node for improving performance of a content sharing system comprising clients wherein the node is a first physical host for storage means for content chunk disposed by a client while logic means for the content chunk is hosted at a second physical host.

14. The node for improving performance of a content sharing system according to claim 13 which node is located at a system central position while the second physical host is located at an edge user position.

15. The node for improving performance of a content sharing system according to claim 13 whereby the node is located at an edge user position while the second physical host is located at a system central position.

16. A method for improving performance of a content sharing system comprising content sharing clients, which method is comprises steps of separating storage and delivering logic for content chunk disposed by a client, into different physical hosts.

17. The method for improving performance of a content sharing system according to claim 16, whereby the clients are arranged so that a central node is situated on a path between external clients and internal clients, wherein an internal client hosts logic facilities for the content chunk, and the central node hosts storage facilities for the content chunk, which method comprises the following further steps:
receiving to the central node from the internal client, an instruction to deliver requested content chunk to a requesting client;
delivering the requested content chunk from the central node to the requesting client.

18. The method for improving performance of a content sharing system according to claim 16, whereby the clients are arranged so that a central node is situated on a path between external clients and internal clients, wherein the central node hosts logic facilities for the content chunk and at least one internal client hosts storage facilities for the content chunk, which method comprises the following further steps:
receiving to the central node from a first requesting internal client, a request for content chunk;
forwarding from the central node, the received request to an external client in disposal of the requested content;
receiving to the central node, the requested content chunk from the external client;
forwarding the chunk from the central node to the first requesting internal client;
forwarding from the central node, the content chunk to storage facilities hosted by at least one of the internal client.

19. Article of manufacturing comprising a program storage medium having a computer readable code embodied therein for improving performance of a content sharing system comprising content sharing clients, which computer readable program code is comprises computer readable program code for separating storage means and logic means for content chunk disposed by a client, into different physical hosts.
